(19) United States
(12) Patent Application Publication
(10) Pub. No.: US 2011/0059848 A1
(43) Pub. Date: Mar. 10, 2011

(54) GRANULAR TURF SAFE HERBICIDAL COMPOSITIONS

(75) Inventors: Robert D. Baker, Westerville, OH (US); Steven T. Kelly, Apopka, FL (US); Charles A. Silcox, Loncoln University, PA (US)

(73) Assignee: E. I. DU PONT DE NEMOURS AND COMPANY, Wilmington, DE (US)

(21) Appl. No.: 12/674,990

(22) PCT Filed: Aug. 29, 2008
(86) PCT No.: PCT/US08/74728

§ 371 Date: Feb. 24, 2010

Related U.S. Application Data
(60) Provisional application No. 60/966,820, filed on Aug. 30, 2007.

(51) Int. Cl. A01N 59/16; A01N 43/54; A01N 59/26; A01N 59/20; A01N 59/14; A01P 13/00

(52) U.S. Cl. 504/121; 504/239; 504/124; 504/136; 504/122

(57) ABSTRACT

Disclosed is a composition comprising (a) one or more compounds selected from the compound of Formula 1 insert Formula 1 here and salts, esters and thioesters thereof, coated on or impregnated into (b) a granular substrate material. The composition is particularly useful for controlling weeds in turf comprising warm-season turfgrasses without causing significant injury to the turfgrasses. Also disclosed is a method for controlling weeds in turf comprising a warm-season turfgrass without causing significant injury to the turfgrass, the method comprising applying a herbicidally effective amount of the composition to the turf.

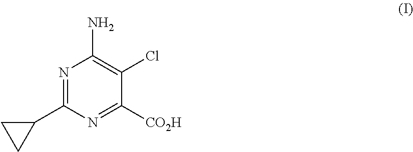

### FIELD OF THE INVENTION

This invention relates to a granular herbicidal composition and a method using the composition to selectively control weeds in warm-season turfgrasses without significantly injuring the grasses.

### BACKGROUND OF THE INVENTION

Because warm-season turfgrasses are capable of C₄ carbon fixation they are better suited than cool-season turfgrasses to thrive during hot weather of not only the tropics but also summers in the warmer regions of the temperate zone. Warm-season turfgrasses are best adapted to temperatures between about 85 and 95° F. (29 to 35° C.), while cool-season grasses grow better at temperatures from about 65 to 75° F. (18 to 24° C.).

Particularly when grown in temperate regions, where for a substantial portion of the year temperatures are below optimum, weed control in turf comprising warm-season turfgrasses presents particular challenges. Rapidly growing established turfgrasses can diminish weed incursion by monopolizing light, water, nutrients and growing space. Therefore during hot summer weather, established turf comprising warm-season turf grasses competes well versus weeds using C₄ carbon fixation and particularly well versus weeds using C₃ carbon fixation, which loses efficiency during hot weather. Weeds using C₃ carbon fixation include many of the most troublesome weeds in turf, including dandelions (Taraxacum officinale), plantains (Plantago spp.), chickweed (Stellaria media) and clovers (Trifolium spp., Kummerowia spp.). With turf comprising warm-season turfgrasses, most weed control problems arise during cooler weather in spring and autumn when C₃ plants grow rapidly and warm-season turfgrasses grow slowly or not at all. Once established, weeds can persist through hot summer weather. Furthermore, as C₃ plants are generally better adapted than C₄ plants to lower light levels, C₃ weeds are particularly troublesome in shady areas of turf comprising warm-season turfgrasses.

While chemical herbicides are commercially available to control weeds, selective control of weeds without excessive injury to turfgrasses is complicated by the varying susceptibility of weed and turfgrass species and varieties to herbicides. As result, weed control at application rates providing sufficient tolerance to turfgrass may be incomplete. Also the duration of weed control may be insufficient. Accordingly new herbicide treatments for selective control of weeds in turf are needed.

PCT Patent Publication WO 2005/063721 discloses a new chemical class of herbicides, including 6-amino-5-chloro-2-cyclopropyl-4-pyrimidinecarboxylic acid (also known by the proposed common name aminocyclopyrachlor) identified as Compound 135 in Index Table A of WO 2005/063721. Index Tables A and B of this publication also identify derivatives including the methyl ester (Compound 9), the ethyl ester (Compound 4), the propyl ester (Compound 75), the butyl ester (Compound 76), the benzyl ester (Compound 78), as well as other esters (Compounds 80, 139-143, 145, 147-150, 164-167), and the sodium salt (Compound 77), the potassium salt (Compound 157), the isopropylammonium salt (Compound 144), the trimethylsulfonium salt (Compound 160) as well as other salts (Compounds 151-156, 158, 159, 161-163). As presented on Aug. 17, 2008 at the 236th National Meeting of the American Chemical Society in Philadelphia by B. L. Finkelstein et al., “Discovery of aminocyclopyrachlor (proposed common name) (DPX-MAT28): A new broad-spectrum auxinic herbicide”, the aminocyclopyrachlor class of herbicide chemistry has an auxinic (i.e. auxin mimic) mode of action.

PCT Patent Publication WO 2005/063721 discloses that aminocyclopyrachlor and its derivatives demonstrate herbicidal activity, both pre- and postemergence, on a wide range of plant species, including grasses as well as dicots. Table C of this publication shows a postemergence spray application of the methyl ester of aminocyclopyrachlor (identified as Compound 9) causing 60% injury to the warm-season turfgrass Bermudagrass (Cynodon dactylon) at an application rate of 31 g ai/ha. Indeed while subsequent testing has shown that spray applications of the methyl ester of aminocyclopyrachlor generally show sufficient safety to most cool-season turfgrasses, such spray applications often cause unacceptable phytotoxicity to not only Bermudagrass but also certain other warm-season turfgrasses such as Centipedegrass (Eremochloa ophiuroides), St. Augustinegrass (Stenotaphrum secundatum) and Zoysiagrass (Zoysia spp.), and mixtures thereof. Accordingly new treatments using aminocyclopyrachlor and its derivatives are needed for successful selective weed control in turf comprising warm-season turfgrasses.

U.S. Pat. No. 5,006,158 discloses that the diverse active compounds of the benzoyl-1,3-cyclohexanedione class of herbicides or salts disclosed therein can be formulated as granules of relatively large particle size, as wettable powders, as emulsifiable concentrates, as powdery dusts, as flowables, as solutions or as any of several other known types of formulations, depending upon the desired mode of application. The formulations containing the actives are disclosed to contain as little as about 0.1% or 0.5% to as much as about 95% or more by weight of active ingredient. A herbicidally effective amount of the actives is disclosed as depending upon the nature of the seeds or plants to be controlled and the rate of application varies from about 0.01 to approximately 10 pounds per acre (11 g/ha to 11 kg/ha), preferably from about 0.02 to about 4 pounds per acre (22 g/ha to 22 kg/ha).

Granular formulations wherein the benzoyl-1,3-cyclohexanedione active ingredients are carried on relatively coarse particles as disclosed in U.S. Pat. No. 5,006,158 are usually applied without dilution to the area in which suppression of vegetation is desired. Typical carriers for such granular formulations as described in U.S. Pat. No. 5,006,158 include sand, fuller's earth, attapulgite clay, bentonite clays, montmorillonite clay, vermiculite, perlite and other organic or inorganic materials which absorb or which may be coated with the toxicant. These granular formulations are normally prepared to contain about 0.1% to about 25% of active ingredients and may include surface-active agents such as heavy aromatic naphthas, kerosene or other petroleum fractions, or vegetable oils; and/or stickers such as dextrins, glue or synthetic resins.

In U.S. Patent Application Publication US 2005/0096226 is disclosed a herbicidal composition useful for controlling weeds in growing crops such as maize (corn) comprising benzoyl-1,3-cyclohexanedione compounds including mesotrione in combination with an organic phosphate, phosphonate or phosphinate adjuvant, which can be prepared as a pre-mix concentrate for formulation in various forms including granular formulations with typical carriers such as sand, fuller's earth, attapulgite clay, bentonite clays, montmorillonite clay, vermiculite, perlite and other organic or inorganic materials which absorb or which can be coated with the active compound.

Mesotrione is commercially available from Syngenta Crop Protection as the active ingredient in two liquid formulation products: Callisto® (containing 40 weight percent mesotrione) marketed as a systemic pre-emergence and post-emergence herbicide for the selective contact and residual control of broadleaf and grassy weeds in field corn, production seed field corn, field corn grown for silage, yellow popcorn and sweet corn, and Tenacity® (containing 40 weight percent mesotrione) marketed as a systemic pre-emergence and post-emergence herbicide for the selective contact and residual control of broadleaf and grassy weeds in turfgrasses for golf courses and sod farms. Mesotrione is well known to function as a p-hydroxyphenyl pyruvate inhibitor, which ultimately blocks carotenoid biosynthesis and damages photosynthetic tissues, resulting in bleaching of leaves followed by necrosis of the meristematic tissue. This mode of action is completely different from that of auxin-mimic herbicides, which cause phytotoxic growth abnormalities.

In U.S. Patent Application Publication US 2007/0021305 a present inventor found that mesotrione applied as a liquid in spray form (e.g., as described in U.S. Pat. Nos. 5,006,158, 6,890,889 and in U.S. Patent Application Publication US 2005/0096226) is not effective for use in controlling weeds in turfgrasses without causing unacceptable injury to the grasses. Specifically, mesotrione containing formulations in spray form demonstrated unacceptable levels of damage/phytotoxicity to a range of turfgrass varieties including perennial ryegrass (Lolium perenne), fine fescue (Festuca spp.), Kentucky bluegrass (Poa pratensis), tall fescue (Festuca arundinacea), zoysiagrass (Zoysia spp.), St. Augustinegrass (Stenotaphrum secundatum), centipedegrass (Eremochloa ophiuroides). However, the phytotoxicity of mesotrione to perennial ryegrass, fine fescue, Kentucky bluegrass, tall fescue, zoysiagrass, St. Augustinegrass and centipedegrass was reduced to insignificant levels while still retaining good weed control by applying the mesotrione in a granular composition.

### SUMMARY OF THE INVENTION

This invention relates to a granular herbicidal composition useful for controlling weeds in turf comprising a warm-season turfgrass without causing significant injury to the warm-season turfgrass. More particularly, this invention is directed to a granular herbicidal composition comprising (a) one or more compounds selected from the compound of Formula 1 (6-amino-5-chloro-2-cyclopropyl-4-pyrimidinecarboxylic acid, aminocyclopyrachlor)

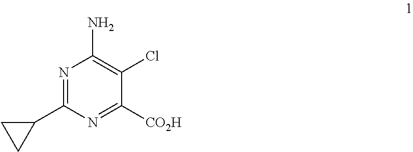

and salts, esters and thioesters thereof, coated on or impregnated into (b) a granular substrate material.

This invention also relates to a method for controlling weeds in turf comprising a warm-season turfgrass without causing significant injury to the warm-season turfgrass, the method comprising applying a herbicidally effective amount of aforesaid composition to the turf.

### DETAILS OF THE INVENTION

As used herein, the terms “comprises,” “comprising,” “includes,” “including,” “has,” “having”, “contains” or “containing” or any other variation thereof, are intended to cover a non-exclusive inclusion. For example, a composition, process, method, article, or apparatus that comprises a list of elements is not necessarily limited to only those elements but may include other elements not expressly listed or inherent to such composition, process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

In the present disclosure and claims, the term “acid equivalent” and related terms such as “acid-equivalent basis” used to specify the amounts of an ester, thioester or salt of the compound of Formula 1 refers to the weight of the compound of Formula 1 (i.e. the carboxylic acid) corresponding in molar amount to the ester, thioester or salt. For example, the compound of Formula 1 has a molecular weight of 213.62 g/mole, while its methyl ester has a molecular weight of 227.65 g/mole. So 227.65 g of the methyl ester can be said to be in the amount of 213.62 g on an acid-equivalent basis.

In the present disclosure and claims, the term “turfgrass” refers to bunch and sod-forming grass species and varieties that have foliage and growth habits suitable for periodically mowed turf used for golf courses and other sporting areas, lawns, and roadsides. In the present disclosure and claims the term “warm-season turfgrass” refers to turfgrass species and varieties that require warm weather as well as soil moisture for substantial growth. Physiologically, warm-season turfgrasses use C₄ carbon fixation, which first converts carbon dioxide to oxaloacetate, a 4-carbon acid. In contrast, cool-season turfgrasses use C₃ carbon fixation, which involves directly fixing carbon dioxide by the enzyme ribulose bisphosphate carboxylase (RUBPcase) in the chloroplast. Accordingly in the present disclosure and claims the “warm-season turfgrasses” are particularly characterized by their ability to use C₄ carbon fixation. C₄ carbon fixation is more efficient than C₃ carbon fixation for supporting growth in hot weather. Accordingly, warm-season turfgrasses generally cease growing at soil temperatures below about 60° F. (16° C.), while cool-season turfgrasses can grow at soil temperatures as low as about 40° F. (4° C.). Warm-season turfgrasses grow best at air temperatures around 85 to 95° F. (29 to 35° C.) (compared to 65 to 75° F. (18 to 24° C.) for cool-season turfgrasses). Warm-season grasses enter dormant or near dormant states as temperatures approach freezing, and their foliage typically loses green color (e.g., turns brown or straw-colored). Common examples of warm-season turfgrasses include Axonopus fissifolius (Raddi) Kuhlm. (also known as Axonopus affinis Chase, Common carpetgrass), Bouteloua dactyloides (Nutt.) J. T. Columbus (also known as Buchloe dactyloides (Nutt.) Engelm., Buffalograss), Cynodon dactylon (L.) Pers. (Common Bermudagrass, Bermudagrass), Cynodon dactylon (L.) Pers. x C. transvaalensis Burtt-Davy (Hybrid Bermudagrass), Eremochloa ophiuroides (Munro) Hack. (Centipede grass, Common Centipedegrass), Paspalum notatum Flueggé. (Bahiagrass), Paspalum vaginatum Sw. (Seashore paspalum), Stenotaphrum secundatum (Walter) Kuntze (St. Augustine grass, St. Augustinegrass), Zoysia japonica Steud. (Korean lawngrass, Japanese lawngrass), Zoysia matrella (L.) Merr. (Manila grass) and Zoysia tenuifolia Willd. ex Thiele (Mascarene grass). Of note for the present method are A. fissifolius, C. dactylon, C. dactylon x C. transvaalensis, E. ophiuroides, P. notatum, P. vaginatum, S. secundatum, Z. japonica, Z. matrella, and Z. tenuifolia, particularly C. dactylon, C. dactylon x C. transvaalensis, E. ophiuroides, P. notatum, P. vaginatum, S. secundatum, Z. japonica, Z. matrella and Z. tenuifolia, and most particularly C. dactylon, C. dactylon x C. transvaalensis, E. ophiuroides, P. notatum, S. secundatum, Z. japonica, Z. matrella, and Z. tenuifolia.

In the present disclosure and claims, “turf” refers to the locus of a layer comprising grass plants with roots and root-entrained growing medium (e.g., soil) attached. Turf can further comprise plants that are not turfgrasses, including undesired vegetation (i.e. weeds). Application of a granular composition to turf typically delivers granules to the region of the soil surface within the turf, which comprises the base of plant foliage (e.g., tillers, stems) and the top of the root zones of turfgrasses and other plants.

As is generally understood in the art, control of undesired vegetation (i.e. weeds) includes killing or injuring the undesired vegetation or reducing its growth. In the context of the present invention, vegetation other than turfgrasses growing in turf is generally regarded as undesired. In the present method, control typically involves killing weeds to remove them as competitors of warm-season turfgrasses for water, nutrients, sunlight and growing space, as well as providing a more homogeneous appearance of the turf comprising the warm-season turfgrasses.

In the present disclosure and claims, “insignificant injury” to turfgrass is the amount of slight injury (e.g., growth reduction or change in turf color) generally noticeable to only a person professionally trained in chemical weed control and not to an untrained person (e.g., homeowner), who would typically not regard the turf appearance as unusual. In contrast, “significant injury” to turfgrass is noticeable by most people. Significant injury can include major growth reduction (difference between treated and untreated), easily noticeable yellowing of turfgrass (chlorosis) or browning of turfgrass (necrosis).

Embodiments of the present invention include:
Embodiment A1. The composition or method described in the Summary of the Invention wherein component (a) (i.e. one or more compounds selected from the compound of Formula 1 and salts, esters and thioesters thereof) is selected from esters and salts of the compound of Formula 1.
Embodiment A2. The composition or method described in the Summary of the Invention wherein component (a) is selected from esters of the compound of Formula 1.
Embodiment A3. The composition or method described in the Summary of the Invention or Embodiment A1 or A2 wherein the esters of the compound of Formula 1 are selected from C₁-C₁₄ alkyl, C₂-C₁₄ alkoxyalkyl, C₃-C₁₄ alkoxyalkoxyalkyl, C₂-C₁₄ hydroxyalkyl and benzyl esters of the compound of Formula 1.
Embodiment A4. The composition or method of Embodiment A3 wherein the esters of the compound of Formula 1 are selected from C₁-C₄ alkyl esters of the compound of Formula 1.
Embodiment A5. The composition or method of Embodiment A4 wherein the esters of the compound of Formula 1 are selected from C₁-C₂ alkyl esters of the compound of Formula 1.
Embodiment A6. The composition or method of any one of Embodiments A1 through A5 wherein component (a) comprises the methyl ester of the compound of Formula 1.
Embodiment A7. The composition or method of Embodiment A6 wherein component (a) is the methyl ester of the compound of Formula 1.
Embodiment A8. The composition or method of Embodiment A1 wherein component (a) is selected from salts of the compound of Formula 1.
Embodiment A9. The composition or method described in the Summary of the Invention or Embodiment A1 or A8 wherein the salts of the compound of Formula 1 are selected from ammonia (i.e. ammonium), amine (i.e. ammonium substituted with carbon-based substituents) and alkali metal salts of the compound of Formula 1.
Embodiment A10. The composition or method of Embodiment A9 wherein the salts of the compound of Formula 1 are selected from the ammonium, dimethylammonium and isopropylammonium salts of the compound of Formula 1.
Embodiment A11. The composition or method of Embodiment A9 wherein the salts of the compound of Formula 1 are selected from the lithium, sodium and potassium salts of the compound of Formula 1.
Embodiment A12. The composition or method of Embodiment A11 wherein the salts of the compound of Formula 1 are selected from the sodium and potassium salts of the compound of Formula 1.
Embodiment A13. The composition or method of any one of Embodiments A1, A8, A9, A11 and A12 wherein component (a) comprises the potassium salt of the compound of Formula 1.
Embodiment A14. The composition or method of Embodiment A13 wherein component (a) is the potassium salt of the compound of Formula 1.
Embodiment A15. The composition or method described in the Summary of the Invention or any one of Embodiments A1 through A14 wherein component (a) is at least about 0.005% by weight of the composition on an acid-equivalent basis.
Embodiment A16. The composition or method of Embodiment A15 wherein component (a) is at least about 0.05% by weight of the composition on an acid-equivalent basis.
Embodiment A17. The composition or method described in the Summary of the Invention or any one of Embodiments A1 through A16 wherein component (a) is no more than about 2% by weight of the composition on an acid-equivalent basis.
Embodiment A18. The composition or method of Embodiment A17 wherein component (a) is no more than about 0.2% by weight of the composition on an acid-equivalent basis.
Embodiment A19. The composition or method described in the Summary of the Invention or any one of Embodiments A1 through A18 wherein component (a) is coated on component (b) (i.e. the granular substrate material).
Embodiment A20. The composition or method described in the Summary of the Invention or any one of Embodiments A1 through A18 wherein component (a) is impregnated into component (b).
Embodiment B1. The composition or method described in the Summary of the Invention or any one of Embodiments A1 through A20 wherein the granular substrate (i.e. component (b)) is selected from the group consisting of solid fertilizer granules, granules consisting of inert solid carrier materials and mixtures thereof.
Embodiment B2. The composition or method of Embodiment B1 wherein the granular substrate comprises fertilizer granules (which for this and subsequent Embodiments are recognized to be solid).
Embodiment B3. The composition or method of Embodiment B1 or B2 wherein the fertilizer granules comprise one or more compounds selected from the group consisting of organic and inorganic nitrogen-containing compounds, potassium salts and phosphoric acid and/or salts of phosphoric acid (including mixtures thereof).
Embodiment B4. The composition or method of any one of Embodiments B1 through B3 wherein the fertilizer granules comprise one or more compounds selected from organic and inorganic nitrogen-containing compounds.
Embodiment B5. The composition or method of Embodiment B3 or B4 wherein the organic and inorganic nitrogen-containing compounds are selected from the group consisting of urea, urea-formaldehyde condensation products, amino acids, ammonium nitrate and other ammonium salts (including mixtures thereof).
Embodiment B6. The composition or method of any one of Embodiments B3 through B5 wherein the potassium salts are selected from the group consisting of potassium chloride, potassium sulfate and potassium nitrate (including mixtures thereof).
Embodiment B7. The composition or method of any one of Embodiments B1 through B6 wherein the fertilizer granules comprise one or more micronutrients.
Embodiment B8. The composition or method of Embodiment B7 wherein the micronutrients are selected from the group consisting of iron, manganese, magnesium, boron, copper and zinc (including mixtures thereof).
Embodiment B9. The composition or method of Embodiment B7 or B8 wherein the micronutrients are in a total amount of from about 1 to about 1000 parts per million by weight of the fertilizer granules.
Embodiment B10. The composition or method of any one of Embodiments B1 through B9 wherein the chemical analysis of the fertilizer granules ranges from about 1% to about 40% by weight nitrogen (as N).
Embodiment B11. The composition or method of Embodiment B10 wherein the chemical analysis of the fertilizer granules is at least about 15% nitrogen.
Embodiment B12. The composition or method of Embodiment B10 or B11 wherein the chemical analysis of the fertilizer granules in no more than about 32% by weight nitrogen.
Embodiment B13. The composition or method of any one of Embodiments B1 through B12 wherein the chemical analysis of the fertilizer granules ranges from about 1% to about 30% by weight phosphorus (as P₂O₅).
Embodiment B14. The composition or method of Embodiment B13 wherein the chemical analysis of the fertilizer granules is at least about 2% by weight phosphorus.
Embodiment B15. The composition or method of Embodiment B13 or B14 wherein the chemical analysis of the fertilizer granules is no more than about 25% by weight phosphorus.
Embodiment B16. The composition or method of any one of Embodiments B1 through B15 wherein the chemical analysis of the fertilizer granules ranges from about 1% to about 20% by weight potassium (as K₂O).
Embodiment B17. The composition or method of Embodiment B16 wherein the chemical analysis of the fertilizer granules is at least about 3% by weight potassium.
Embodiment B18. The composition or method of Embodiment B16 or B17 wherein the chemical analysis of the fertilizer granules is no more than about 15% by weight potassium.
Embodiment B19. The composition or method of any one of Embodiments B1 through B18 wherein the fertilizer granules have diameters within a range from about 1 to about 5 mm.
Embodiment B20. The composition or method of any one of Embodiments B1 through B18 wherein the fertilizer granules include extruded particles.
Embodiment B21. The composition or method of Embodiment B20 wherein the extruded particles have diameters within a range from about 0.6 to about 7 mm.
Embodiment B22. The composition or method of Embodiment B21 wherein the diameters of the extruded particles are at least about 1 mm.
Embodiment B23. The composition or method of Embodiment B21 or B22 wherein the diameters of the extruded particles are no more than about 3 mm.
Embodiment B24. The composition or method of any one of Embodiments B20 through B23 wherein the extruded particles have lengths within a range from about 0.6 to about 10 mm.
Embodiment B25. The composition or method of Embodiment B24 wherein the lengths of the extruded particles are at least about 1 mm.
Embodiment B26. The composition or method of Embodiment B24 or B25 wherein the lengths of the extruded particles are no more than about 5 mm.
Embodiment B27. The composition or method of any one of Embodiments B1 through B26 wherein the granules consisting of inert solid carrier materials comprise one or more inert solid carrier materials selected from the group consisting of corncobs, peanut hulls, processed paper pulp, sawdust, limestone, sand, vermiculite, perlite, fuller's earth, attapulgite clays, bentonite clays and montmorillonite clays (including mixtures thereof).
Embodiment B28. The composition as described in the Summary of the Invention or any one of Embodiments A1 through A20 and B1 through B27 formulated for treating turf at an application rate of component (a) from about 0.025 lb/acre (28 g/ha) to about 0.2 lb/acre (220 g/ha) on an acid-equivalent basis.
Embodiment B29. The composition of Embodiment B28 formulated for treating turf at an application rate of component (a) from about 0.025 lb/acre (28 g/ha) to about 0.15 lb/acre (170 g/ha) on an acid-equivalent basis.
Embodiment C1. The method described in the Summary of the Invention or any one of Embodiments A1 through A20 and B1 through B27 wherein the turf comprises one or more warm-season turfgrasses selected from the group consisting of Axonopus fissffolius, Bouteloua dactyloides, Cynodon dactylon, Cynodon dactylon x C. transvaalensis, Eremochloa ophiuroides, Paspalum notatum, Paspalum vaginatum, Stenotaphrum secundatum, Zoysia japonica, Zoysia matrella and Zoysia tenuifolia (including mixtures thereof).
Embodiment C2. The method of Embodiment C1 wherein the turf comprises one or more warm-season turfgrasses selected from the group consisting of A. fissifolius, C. dactylon, C. dactylon x C. transvaalensis, E. ophiuroides, P. notatum, P. vaginatum, S. secundatum, Z. japonica, Z matrella, and Z. tenuifolia (including mixtures thereof).
Embodiment C3. The method of Embodiment C2 wherein the turf comprises one or more warm-season turfgrasses selected from the group consisting of C. dactylon, C. dactylon x C. transvaalensis, E. ophiuroides, P. notatum, P. vaginatum, S. secundatum, Z. japonica, Z. matrella and Z. tenuifolia (including mixtures thereof).
Embodiment C4. The method of Embodiment C3 wherein the turf comprises one or more warm-season turfgrasses selected from the group consisting of C. dactylon, C. dactylon x C. transvaalensis, E. ophiuroides, P. notatum, S. secundatum, Z. japonica, Z. matrella, and Z. tenuifolia (including mixtures thereof).
Embodiment C5. The method of Embodiment C4 wherein the turf comprises one or more warm-season turfgrasses selected from the group consisting of C. dactylon x C. transvaalensis, S. secundatum and E. ophiuroides (including mixtures thereof).
Embodiment C6. The method of Embodiment C5 wherein the turf comprises one or more warm-season turfgrasses selected from the group consisting of C. dactylon x C. transvaalensis and S. secundatum (including mixtures thereof).
Embodiment C7. The method of Embodiment C6 wherein the turf comprises C. dactylon x C. transvaalensis (Hybrid Bermudagrass).
Embodiment C8. The method of Embodiment C6 wherein the turf comprises S. secundatum (St. Augustinegrass).
Embodiment C9. The method described in the Summary of the Invention or any one of Embodiments A1 through A20, B1 through B27 and C1 through C8 wherein the composition is applied postemergence to the warm-season turfgrass.
Embodiment C10. The method described in the Summary of the Invention or any one of Embodiments A1 through A20, B1 through B27 and C1 through C9 wherein the composition is applied at a rate of at least about 0.025 lb per acre (about 28 g/ha) of component (a) on an acid-equivalent basis.
Embodiment C11. The method of Embodiment C10 wherein the composition is applied at a rate of at least about 0.5 lb per acre (about 56 g/ha) of component (a) on an acid-equivalent basis.
Embodiment C12. The method of Embodiment C11 wherein the composition is applied at a rate of at least about 60 g/ha of component (a) on an acid-equivalent basis.
Embodiment C13. The method described in the Summary of the Invention or any one of Embodiments A1 through A20, B1 through B27 and C1 through C12 wherein the composition is applied at a rate of no more than about 0.3 lb per acre (about 340 g/ha) of component (a) on an acid-equivalent basis.
Embodiment C14. The method of Embodiment C13 wherein the composition is applied at a rate of no more than about 0.2 lb per acre (about 220 g/ha) of component (a) on an acid-equivalent basis.
Embodiment C15. The method of Embodiment C14 wherein the composition is applied at a rate of no more than about 0.15 lb per acre (about 170 g/ha) of component (a) on an acid-equivalent basis.
Embodiment C16. The method of Embodiment C15 wherein the composition is applied at a rate of no more than about 150 g/ha of component (a) on an acid-equivalent basis.
Embodiment C17. The method described in the Summary of the Invention or any one of Embodiments A1 through A20, B1 through B27 and C1 through C16 wherein the weeds controlled are selected from the group consisting of Annual blue-eyed grass (Sisyrinchium rosulatum), Black medic (Medicago lupulina), Burweed (Soliva sessilis and other Soliva spp.), Carolina geranium (Geranium carolianum), Chickweed (Stellaria media), Clover (Trifolium repens and other Trifolium spp., Kummerowia striata and other Kummerowia spp.), Common yarrow (Achillea millefolium), Curly dock (Rumex crispus), Dandelion (Taraxacum officinale), Dogfennel (Eupatorium capillifolium), Eastern poison ivy (Toxicodendron radicans), Everlasting (Gamochaeta spp.), Gale of the wind (Phyllanthus niruri), Goldenrod (Solidago spp.), Ground ivy (Glechoma hederacea), Hawkweed (Hieracium spp.), Henbit (Lamium amplexicaule), Mallow (Abutilon spp.), Mouse-ear chickweed (Cerastium fontanum), Pennywort (Hydrocotyle spp.), Plantain (Plantago spp.), Purslane (Portulaca amilis and other Portulaca. spp.), Selfheal (Prunella vulgaris), Speedwell (Veronica spp.), Turkey tangle fogfruit (Phyla nodiflora), Violet (Viola arvensis and other Viola spp.) and Virginia buttonweed (Diodia virginiana) (including mixtures thereof).
Embodiment C18. The method of Embodiment C17 wherein the weeds controlled are selected from the group consisting of Sisyrinchium rosulatum, Medicago lupulina, Soliva sessilis and other Soliva spp., Geranium carolianum, Stellaria media, Trifolium repens and other Trifolium spp., Kummerowia striata, Taraxacum officinale, Eupatorium capillifolium, Toxicodendron radicans, Gamochaeta spp., Phyllanthus niruri, Solidago spp., Glechoma hederacea, Lamium amplexicaule, Hydrocotyle, Plantago spp., Portulaca amilis and other Portulaca. spp., Veronica spp., Phyla nodiflora, Viola arvensis and other Viola spp., and Diodia virginiana (including mixtures thereof).
Embodiment C19. The method of Embodiment C18 wherein the weeds controlled are selected from the group consisting of Medicago lupulina, Trifolium repens and other Trifolium spp., Kummerowia striata, Taraxacum officinale, Glechoma hederacea, Hydrocotyle spp., and Viola arvensis and other Viola spp. (including mixtures thereof).
Embodiment C20. The method of any one of Embodiments C17 through C19 wherein the weeds controlled are further selected from crabgrass (Digitaria spp.) (i.e. crabgrass is added to the lists of weeds defining the groups).
Embodiment C21. The method described in the Summary of the Invention or any one of Embodiments A1 through A20, B1 through B27 and C1 through C16 wherein the weeds controlled are selected from crabgrass (Digitaria spp.).

Also of note as embodiments are:
Embodiment P1. A granular herbicidal composition for use in controlling weeds in a warm season turfgrass without causing significant injury to the warm season turfgrass comprising the methyl ester of the compound of Formula 1 coated on or impregnated into a granular substrate material.
Embodiment P2. The composition of Embodiment P1 wherein the granular substrate is selected from the group consisting of solid fertilizer granules, inert solid carrier materials and mixtures thereof.
Embodiment P3. The composition of Embodiment P2 wherein the solid fertilizer granules are selected from the group consisting of organic and inorganic nitrogen-containing compounds, potassium salts and phosphoric acid and/or salts of phosphoric acid and mixtures thereof.
Embodiment P4. The composition of Embodiment P2 wherein the solid fertilizer granules are organic and inorganic nitrogen-containing compounds.
Embodiment P5. The composition of Embodiment P4 wherein the composition is formulated to provide a weight percentage of the methyl ester of the compound of Formula 1 when applied to a warm season turfgrass calculated in accordance with the formula:

A=X(Y÷Z)

wherein
A is the weight percentage of the methyl ester of the compound of Formula 1 provided by the composition when applied to a warm season turfgrass;
X is the application rate in pounds per acre of the methyl ester of the compound of Formula 1 provided when the composition is applied to treat the warm season turfgrass;
Y is the weight percentage of Nitrogen in the composition; and
Z is the application rate in pounds per acre of Nitrogen provided when the composition is applied to treat the warm season turfgrass.
Embodiment P6. The composition of Embodiment P2 wherein the fertilizer granules include micronutrients.
Embodiment P7. The composition of Embodiment P3 wherein the organic and inorganic nitrogen-containing compounds are selected from the group consisting of urea, urea-formaldehyde condensation products, amino acids, ammonium salts, ammonium nitrates and mixtures thereof.
Embodiment P8. The composition of Embodiment P3 wherein the potassium salts are selected from the group consisting of potassium chlorides, potassium sulfates, potassium nitrates and mixtures thereof.
Embodiment P9. The composition of Embodiment P6 wherein the micronutrients are selected from the group consisting of iron, manganese, magnesium, boron, copper, zinc and mixtures thereof.
Embodiment P10. The composition of Embodiment P2 wherein the fertilizer granules include extruded particles.

Embodiment P11. The composition of Embodiment P2 wherein the fertilizer granule size range from about 1.0 to about 5.0 mm diameter.
Embodiment P12. The composition of Embodiment P10 wherein the granule size range of the extruded particles ranges from about 0.6 to about 7.0 mm diameter and the particle length ranges from about 0.6 to about 10.0 mm.
Embodiment P13. The composition of Embodiment P3 wherein the chemical analysis of the fertilizer granules ranges from about 1 to about 40% by weight nitrogen, about 1 to about 30% by weight phosphorus and about 1 to about 20% by weight potassium.
Embodiment P14. The composition of Embodiment P9 wherein the micronutrient content of the fertilizer granules ranges from about 1 to about 1,000 parts per million.
Embodiment P15. The composition of Embodiment P1 wherein the quantity of the methyl ester of the compound of Formula 1 in the composition ranges from about 0.005% to about 2.0% by weight of the composition.
Embodiment P16. The composition of Embodiment P2 wherein the inert solid carrier materials are selected from the group consisting of corncobs, peanut hulls, processed paper pulp, sawdust, limestone, sand, vermiculite, perlite, fuller's earth, attapulgite clays, bentonite clays, montmorillonite clays and mixtures thereof.
Embodiment P17. The composition of Embodiment P1 formulated for treating St. Augustinegrass at an application rate of about 0.075 to about 0.150 lb granular methyl ester of the compound of Formula 1/acre (84-168 g/ha).
Embodiment P18. The composition of Embodiment P1 formulated for treating Hybrid Bermudagrass at an application rate of about 0.075 to about 0.2 lb granular methyl ester of the compound of Formula 1/acre (84-224 g/ha).
Embodiment P19. A method for controlling the growth of weeds in a warm season turfgrass without causing significant injury to the warm season turfgrass comprising applying a composition containing the methyl ester of the compound of Formula 1 coated on or impregnated into a granular substrate material to the turfgrass.
Embodiment P20. The method of Embodiment P19 wherein the warm season turfgrass is selected from the group consisting of St. Augustinegrass and Hybrid Bermudagrass and mixtures thereof.
Embodiment P21. The method of Embodiment P19 wherein the granular substrate is selected from the group consisting of solid fertilizer granules, inert solid carrier materials and mixtures thereof.
Embodiment P22. The method of Embodiment P21 wherein the solid fertilizer granules are selected from the group consisting of organic and inorganic nitrogen-containing compounds, potassium salts and phosphoric acid and/or salts of phosphoric acid and mixtures thereof.
Embodiment P23. The method of Embodiment P21 wherein the fertilizer granules include micronutrients.
Embodiment P24. The method of Embodiment P22 wherein the organic and inorganic nitrogen-containing compounds are selected from the group consisting of urea, urea-formaldehyde condensation products, amino acids, ammonium salts, ammonium nitrates and mixtures thereof.
Embodiment P25. The method of Embodiment P21 wherein the composition is formulated to provide a weight percentage of the methyl ester of the compound of Formula 1 when applied to the turfgrass calculated in accordance with the formula:

A=X(Y÷Z)

wherein
A is the weight percentage of the methyl ester of the compound of Formula 1 provided by the composition when applied to the warm season turfgrass;
X is the application rate in pounds per acre of the methyl ester of the compound of Formula 1 provided when the composition is applied to treat the warm season turfgrass;
Y is the weight percentage of Nitrogen in the composition; and
Z is the application rate in pounds per acre of Nitrogen provided when the composition is applied to treat the warm season turfgrass.
Embodiment P26. The method of Embodiment P22 wherein the potassium salts are selected from the group consisting of potassium chlorides, potassium sulfates, potassium nitrates and mixtures thereof.
Embodiment P27. The method of Embodiment P23 wherein the micronutrients are selected from the group consisting of iron, manganese, magnesium boron, copper, zinc and mixtures thereof.
Embodiment P28. The method of Embodiment P21 wherein the fertilizer granules include extruded particles.
Embodiment P29. The method of Embodiment P21 wherein the fertilizer granule size ranges from about 1.0 to about 5.0 mm diameter.
Embodiment P30. The method of Embodiment P28 wherein the granule size range of the extruded particles ranges from about 0.6 to about 7.0 mm diameter and the particle length ranges from about 0.6 to about 10.0 mm.
Embodiment P31. The method of Embodiment P21 wherein the chemical analysis of the fertilizer granules ranges from about 1 to about 40% by weight nitrogen, about 1 to about 30% by weight phosphorous and about 1 to about 20% by weight potassium.
Embodiment P32. The method of Embodiment P27 wherein the micronutrient content of the fertilizer granules ranges from about 1 to about 1,000 parts per million.
Embodiment P33. The method of Embodiment P19 wherein the quantity of the methyl ester of the compound of Formula 1 in the composition ranges from about 0.005% to about 2.0% by weight of the composition.
Embodiment P34. The method of Embodiment P21 wherein the inert solid carrier materials are selected from the group consisting of corncobs, peanut hulls, processed paper pulp, sawdust, limestone, sand, vermiculite, perlite, fuller's earth, attapulgite clays, bentonite clays, montmorillonite clays and mixtures thereof.
Embodiment P35. The method of Embodiment P19 wherein the composition is applied to St. Augustinegrass at an application rate of about 0.05 to about 0.150 lb granular methyl ester of the compound of Formula 1/acre (56-168 g/ha).
Embodiment P36. The method of Embodiment P19 wherein the composition is applied to Hybrid Bermudagrass at an application rate of about 0.05 to about 0.2 lb granular methyl ester of the compound of Formula 1/acre (56-224 g/ha).

Embodiments of this invention, including Embodiments A1-P36 above, as well as any other embodiments described herein, can be combined in any manner. Of note is a granular herbicidal composition for use in controlling weeds in turf comprising a warm-season turfgrass without causing significant injury to the warm-season turfgrass, the composition comprising (a) one or more compounds selected from the compound of Formula 1 and salts, esters and thioesters thereof, coated on or impregnated into (b) a granular substrate material. Also of note is a granular herbicidal composition comprising (a) one or more compounds selected from the compound of Formula 1 and salts, esters and thioesters thereof, coated on or impregnated into (b) a granular substrate material, wherein the composition is useful for controlling weeds in turf comprising a warm-season turfgrass without causing significant injury to the warm-season turfgrass. Embodiments A1 through A20 and B1 through B29 also relate to the aforesaid compositions of note.

In the present composition one or more compounds selected from the compound of Formula 1 and salts, esters and thioesters thereof (i.e. component (a)) are coated on or impregnated into a solid granular substrate (i.e. component (b)), which is preferably a fertilizer material. Alternatively, a suitable inert solid carrier material may be employed with or in substitution for the fertilizer material. The resulting compositions have been found to be highly effective for use in controlling the growth of weeds in warm-season turfgrasses without causing significant injury to the turfgrasses when applied thereto. Accordingly the present invention provides granular compositions (i.e. formulations) containing component (a) for safe and effective herbicidal treatment of warm-season turfgrass species whereby weeds growing, for example, in a lawn can be controlled without causing undue phytotoxic effects on the grasses themselves. Another aspect of the present invention is a granular turf-safe composition comprising component (a) for herbicidal treatment of weeds in warm-season turfgrasses. A further aspect of the present invention is a method for effective and efficient control or weeds in warm-season turfgrasses without causing significant injury to the turfgrasses by applying a granular composition containing component (a) to turf comprising the warm-season grasses.

As already mentioned, the compound of Formula 1 can be included in component (a) as a salt. One skilled in the art recognizes that in the environment and under physiological conditions salts of the compound of Formula 1 are in equilibrium with the nonsalt forms, and therefore a salt shares the biological utility of the nonsalt form. Thus a wide variety of salts of the compound of Formula 1 are useful in the context of the present invention.

As is well known in the art, contact of an acidic functional group (e.g., carboxylic acid) with a base forms a salt comprising the corresponding anion derived from the acidic functional group and a positively charged counterion derived from the base. For example, a salt is formed with an amine base (e.g., pyridine, ammonia, triethylamine, isopropylamine), another organic base (e.g., a quaternary ammonium hydroxide), or an inorganic base (e.g., amides, hydrides, hydroxides, or carbonates of sodium, potassium, lithium, calcium, magnesium or barium). When a compound includes a basic function (e.g., amino or another moiety comprising a nitrogen atom with an available pair of electrons) salts can also include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids.

The compound of Formula 1 (6-amino-5-chloro-2-cyclopropyl-4-pyrimidinecarboxylic acid)

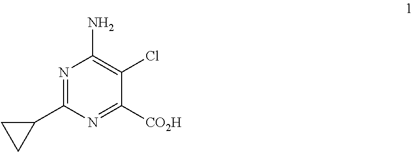

comprises a carboxylic acid functional group (—CO₂H) capable of deprotonation and forming salts with bases and also comprises an amino substituent (—NH₂) and pyrimidine ring nitrogen atoms with free pairs of electrons capable of protonation and forming salts with acids. Particularly useful for the present composition and method are salts formed with bases. Of note are such salts wherein the counterion is formed from an ammonia or an amine (e.g., ammonium, dimethylammonium or isopropylammonium) or is an alkali metal cation (e.g., potassium, sodium or lithium). Particularly noteworthy for the present composition and method are the sodium and potassium salts of the compound of Formula 1. These salts have excellent solubility in water.

Also particularly useful as derivatives of the corresponding carboxylic acid of Formula 1 in the present composition and method are ester and thioester derivatives. The carboxylic acid form (i.e. Formula 1) is believed to be the compound that binds to active sites on plant enzymes or receptors causing herbicidal activity. However, ester and thioester derivatives can be transformed within the plant or the environment to the parent carboxylic acid, and therefore these derivatives also have herbicidal utility. Accordingly, ester and thioester as well as salt derivatives are useful for the present composition and method.

Ester groups (i.e. CO₂R^{AL}) result from condensation of a carboxylic acid (CO₂H) with an alcohol (i.e. R^{AL}OH) wherein R^{AL} is the radical derived from the alcohol. Thioester groups of the formula C(O)SR^{AL} may be conceptually viewed as the condensation product of a carboxylic acid function with a thioalcohol (often called a mercaptan) of the formula R^{AL}SH. There is a wide variety of general methods known in the art for preparing carboxylic esters and thioesters from carboxylic acids.

If the radical R^{AL} has more than one OH or SH function attached, the radical may be condensed with more than one carboxylic acid of Formula 1. As these multiply esterified derivatives can be hydrolyzed to the parent carboxylic acids, these derivatives are among the ester derivatives useful for the present method. Illustrative thioester derivatives include the compounds of Forniula 1 thioesterified with alkylthiols such as methanethiol, ethanethiol or propanethiol. Illustrative ester derivatives include the compound of Formula 1 esterified with alcohols such as methanol, ethanol, propanol, isopropanol, t-butanol, 2-methoxyethanol, 2-ethoxyethanol, 2-propoxyethanol, 2-butoxyethanol or benzyl alcohol to form methyl, ethyl, propyl, i-propyl, t-butyl, 2-methoxyethyl, 2-ethoxyethyl, 2-propoxyethyl, 2-butoxyethyl and benzyl esters, respectively.

Illustrative as compounds from which component (a) in the present method is selected are compounds of Formula 1a, and salts thereof,

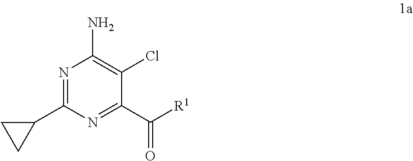

wherein
R¹ is OR² or SR³;
R² is H, C₁-C₁₄ C₂-C₁₄ alkoxyalkyl, C₃-C₁₄ alkoxyalkoxyalkyl, C₂-C₁₄ hydroxyalkyl or benzyl; and
R³ is C₁-C₁₄ alkyl, C₂-C₁₄ alkoxyalkyl, C₃-C₁₄ alkoxyalkoxyalkyl, C₂-C₁₄ hydroxyalkyl or benzyl.

Of the ester and thioester derivatives of the carboxylic acids of Formula 1, the ester derivatives are of particular note, as they are generally more conveniently prepared, least expensive and most useful. Therefore of note for the present composition and method are compounds of Formula 1a wherein R¹ is OR² and salts thereof, and of particular note are compounds of Formula 1a wherein R¹ is OR² and R² is C₁-C₁₄ alkyl, C₂-C₁₄ alkoxyalkyl, C₃-C₁₄ alkoxyalkoxyalkyl, C₂-C₁₄ hydroxyalkyl or benzyl.

For reasons of cost and herbicidal effectiveness, C₁-C₄ alkyl esters are preferred and C₁-C₂ alkyl (i.e. methyl and ethyl) esters are more preferred as esters of the compound of Formula 1.

The compound of Formula 1 and its salt, ester and thioester derivatives can be prepared by the methods described in PCT publications WO 2005/063721, WO 2006/121648 and WO 2006/124657. Table A illustrates specific compounds useful as component (a) for the present method. The following abbreviations are used in Table A: n means normal, t means tertiary, i means iso, Me means methyl, Et means ethyl, n-Pr means n-propyl, i-Pr means isopropyl, n-Bu means butyl, t-Bu means tert-butyl, Ph means phenyl, “,” means negative formal charge, and “+” means positive formal charge.

TABLE A
1a

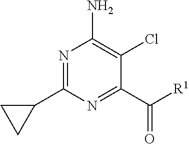

| Compound | |
|---|---|
| Number | R¹ |
| 1 | —OMe |
| 2 | —OEt |
| 3 | —O—n-Pr |
| 4 | —O—i-Pr |
| 5 | —O—t-Bu |
| 6 | —OCH₂Ph |
| 7 | —O—n-Bu |
| 8 | —OCH₂CH₂CH₂OH |
| 9 | —OCH(CH₃)(CH₂)₅CH₃ |
| 10 | —OCH₂CH₂O(CH₂)₂OCH₃ |
| 11 | —OCH₂(CH₂)₆CH₃ |
| 12 | —OCH₂CH₂O(CH₂)₃CH₃ |
| 13 | —OCH₂CH(CH₂CH₃)(CH₂)₃CH₃ |
| 14 | —OCH(CH₃)CH₂O(CH₂)₃CH₃ |
| 15 | —SMe |
| 16 | —SEt |
| 17 | —S—n-Pr |
| 18 | —OH |
| 19 | —O, Li⁺ |
| 20 | —O, Na⁺ |
| 21 | —O, K⁺ |
| 22 | —O, Na⁺ |
| 23 | —O, N⁺H₄ |
| 24 | —O, H₃N⁺Me |
| 25 | —O, H₃N⁺i-Pr |
| 26 | —O, HN⁺(Et)₃ |
| 27 | —O, N⁺(Me)₄ |
| 28 | —O, N⁺(Me)₃(CH₂Ph) |
| 29 | —O, S⁺(Me)₃ |

As already mentioned, the solid granular substrate (i.e. component (b) in the present composition is preferably a fertilizer material. Illustrative fertilizers which can be employed for mixture with component (a) (i.e. one or more compounds selected from the compound of Formula 1, and salts, esters and thioesters thereof) to produce the granular herbicidal composition of the present invention include a wide variety of solid fertilizer granules, particles or pellets (which are referred to collectively herein as solid fertilizer granules or, more simply, as fertilizer granules) comprising organic and inorganic nitrogen-containing compounds such as urea, urea-formaldehyde condensation products, amino acids, ammonium nitrate, other ammonium salts and mixtures thereof; potassium salts (preferably potassium chloride, potassium sulfate, potassium nitrate and mixtures thereof) and phosphoric acid and/or salts of phosphoric acid and mixtures thereof. Also, it should be noted that the fertilizer granules suitable for inclusion in the present mixtures may also contain micronutrients, such as iron, manganese, magnesium, boron, copper, zinc and the like and mixtures thereof.

The physical forms of the fertilizers to be employed in combination with component (a) to produce the compositions of the present invention include granules and extruded particles. Fertilizer granule sizes, preferably, should range from about 1 to about 5 mm diameter (most preferably, about 1.5-3 mm). Extruded particle sizes preferably should range from about 0.6 to about 7 mm diameter (most preferably, about 1-3 mm). Particle length preferably should range from about 0.6 to about 10 mm (most preferably, 1-5 mm).

Preferably, the chemical analysis for the fertilizer component to be included in the present compositions should range from about 1 to about 40% by weight nitrogen (preferably, about 15-32%); about 1 to about 30% by weight phosphorus as P₂O₅ (preferably, about 2-25%); and about 1 to about 20% by weight potassium as K₂O (preferably, about 3-15%). The micronutrient content of the fertilizer ingredient, preferably, should range from about 1 to about 1,000 ppm (parts per million).

Preferably, the quantity of component (a) to be incorporated in combination with the fertilizer component to prepare the compositions of the present invention should range from about 0.005% to about 2% (preferably about 0.05% to about 0.2%) by weight, on an acid-equivalent basis, of the total composition.

In an alternative embodiment of the present invention, granules containing inert solid carriers can be admixed with component (a) (i.e. one or more compounds selected from the compound of Formula 1, and salts, esters and thioesters thereof) either with or without the fertilizer constituent to produce a composition for use in accordance with the present invention.

Suitable inert solid carrier materials that can be employed in component (b) include any of a variety of organic and/or inorganic materials which absorb or which may be coated with component (a) and that have been appropriately agglomerated, ground, fractionated and/or sized to prepare granules, particles or pellets (which are referred to collectively herein as granules). The term “inert” in the context of “inert solid carrier materials” refers to chemical substances that do not rapidly (e.g., not within a week) provide substantial amounts of plant nutrients and also do not have biological activity protecting plants from pests, diseases and/or weed competition. In the context of the present disclosure and claims, an organic substance that releases plant nutrients primarily through microbial degradation (which is typically slow) rather than plant metabolism or abiotic degradation is considered an inert solid carrier instead of a fertilizer. A granule comprising both a fertilizer and an inert solid carrier material is considered to be a fertilizer granule. Suitable organic materials for preparing inert solid carriers include corncobs, peanut hulls, processed paper pulp, sawdust and the like, whereas suitable inorganic materials include limestone, sand, vermiculite, perlite, fuller's earth and clays such as attapulgite clays, bentonite clays, montmorillonite clays.

Preferably, the quantity of component (a) to be incorporated in combination with an inert carrier material to prepare the compositions of the present invention should range from about 0.01% to about 0.5% (preferably about 0.06% to about 0.3%) by weight, on an acid-equivalent basis, of the total composition.

In accordance with the present invention, granular herbicidal compositions for use in controlling weeds in a warm-season turfgrass without causing significant injury to the turfgrass are provided comprising component (a) coated on or impregnated into granular substrate materials wherein the granular substrates are solid fertilizer granules, inert solid carrier materials or mixtures thereof. In preferred embodiments, the solid fertilizer granules comprise or consist essentially of organic or inorganic nitrogen-containing compounds. The weight percentage of component (a) that needs to included in a nitrogen-containing fertilizer granule composition to provide a desired application rate of component (a) when the composition is applied to turfgrass to provide a desired amount of nitrogen fertilization can be calculated in accordance with the equation:

A=X·(Y/Z)

wherein
A is the weight percentage of component (a) that needs to be included in the composition;
X is the desired application rate of component (a) in pounds per acre (or kg per hectare) to the turfgrass from application of the composition;
Y is the weight percentage of fertilizer nitrogen in the composition; and
Z is the desired application rate of fertilizer nitrogen in pounds per acre (or kg per hectare) to the turfgrass from application of the composition.

The composition of the present invention can be produced employing any of a variety of processes. For example, component (a) can be: (1) applied to a fertilizer/inert granule as a spray mixture with solvents and/or surfactants; (2) adhered to the outer surface of the fertilizer/inert granule with an adhesive/sticking agent; (3) incorporated into a mixture of dry ingredients and a liquid, then extruded or molded into discrete particles; or (4) impregnated into a porous granule. In process (1), component (a) typically will be impregnated (i.e. infused) in the granular substrate if the granule is porous, or only coated on the surface of the granule if the granule is not porous. In process (2), component (a) typically will be coated on the surface of the granular substrate and if the granule is porous also absorbed into the surface of the granular substrate. In process (3) and (4), component (a) will be impregnated into the granular substrate.

In one embodiment, the composition of the present invention is prepared by mixing component (a) dissolved or dispersed in a liquid carrier with a granular fertilizer in effective amounts (for example, in a rotating drum container) for a sufficient period of time until component (a) is uniformly coated on and absorbed in the fertilizer granules.

Other methods which are particularly convenient for producing the composition of the present invention containing component (a) and fertilizer granules as component (b), and which can also be used with inert carrier granules, include:

(1) Dissolving or dispersing a concentrated formulation comprising component (a) in a liquid solvent optionally comprising a surfactant, and then spraying this mixture on the fertilizer and/or inert carrier material so component (a) is uniformly absorbed on the substrate particles; or

(2) Tacking a dry powder formulation comprising component (a) onto the surface of a fertilizer and/or inert carrier material using a liquid sticking agent or adhesive to obtain a uniform distribution of component (a) over the substrate particles.

The composition of the invention applied to turf comprising a warm-season turfgrass according to the present method can control a wide variety of dicot weeds (also known as broadleaf weeds) and some monocot weeds without significant injury to the warm-season turfgrass. Examples of weeds controlled by the present method include Annual blue-eyed grass (Sisyrinchium rosulatum E. P. Bicknell), Black medic (Medicago lupulina L.), Burweed (Soliva sessilis Ruiz & Pav. and other Soliva spp.), Carolina geranium (Geranium carolianum L.), Chickweed (Stellaria media (L.) Vill.), Clover (Trifolium repens L. and other Trifolium spp., Kummerowia striata (Thunb.) Schindl. and other Kummerowia spp.), Common yarrow (Achillea millefolium L.), Curly dock (Rumex crispus L.), Dandelion (Taraxacum officinale F. H. Wigg.), Dogfennel (Eupatorium capillifolium (Lam.) Small), Eastern poison ivy (Toxicodendron radicans (L.) Kuntze), Everlasting (Gamochaeta spp.), Gale of the wind (Phyllanthus niruri L.), Goldenrod (Solidago spp.), Ground ivy (Glechoma hederacea L.), Hawkweed (Hieracium spp.), Henbit (Lamium amplexicaule L.), Mallow (Abutilon spp.), Mouse-ear chickweed (Cerastium fontanum Baumg.), Pennywort (Hydrocotyle spp.), Plantain (Plantago spp.), Purslane (Portulaca amilis Speg. and other Portulaca spp.), Selfheal (Prunella vulgaris L.), Speedwell (Veronica spp.), Turkey tangle fogfruit (Phyla nodiflora (L.) Greene), Violet (Viola arvensis Murray and other Viola spp.) and Virginia buttonweed (Diodia virginiana L.). Of note for the present method is control of weeds including Sisyrinchium rosulatum, Medicago lupulina, Soliva sessilis and other Soliva spp., Geranium carolianum, Stellaria media, Trifolium repens and other Trifolium spp., Kummerowia striata, Taraxacum officinale, Eupatorium capillifolium, Toxicodendron radicans, Gamochaeta spp., Phyllanthus niruri, Solidago spp., Glechoma hederacea, Lamium amplexicaule, Hydrocotyle, Plantago spp., Portulaca amilis and other Portulaca. spp., Veronica spp., Phyla nodiflora, Viola arvensis and other Viola spp., and Diodia virginiana. The present method works particularly well for control of Medicago lupulina, Trifolium repens and other Trifolium spp., Kummerowia striata, Taraxacum officinale, Glechoma hederacea, Hydrocotyle spp., and Viola arvensis and other Viola spp. Furthermore the present method can be used to control crabgrass (Digitaria spp.) if the composition is applied to the turf preemergence to the crabgrass (i.e. before the crabgrass seeds germinate to form seedlings).

The composition of the invention can be applied to turf at any time throughout the year, but for best control of weeds the composition is typically applied when the weeds are growing or will be soon (e.g., within about a month) growing. Although the composition of the invention can be applied preemergence to turf plots seeded with warm-season turfgrasses, the composition is typically applied postemergence to turfgrasses, most typically past the seedling stage and well established in the turf. Although phytotoxicity to warm-season turfgrasses is substantially reduced by applying component (a) in a granular composition according to the present invention instead of a spray composition, particular application timing may still be desirable to further reduce phytotoxicity, especially with turfgrasses known to be extraordinarily sensitive to auxin-mimic-type (auxinic) herbicides (e.g., buffalograss). Phytotoxicity can be minimized by application when air temperature can be expected to not exceed about 80° F. (27° C.) over about the next 30 days. Phytotoxicity is also minimized by turf application when the turfgrass is going dormant or is already dormant. Of note, particularly for turf comprising highly auxin-herbicide-sensitive turfgrasses such as buffalograss, is application of the granular composition of the present invention when the turfgrass is going dormant during the autumn.

The composition of the invention as described above can be applied at various rates to achieve the desired effect of weed control and turf safety. In general, about 0.025 to about 0.3 lb per acre (about 28 to about 340 g per hectare) of component (a) on an acid-equivalent basis (i.e. herbicidally effective amount of component (a)) is required to control weeds in turfgrass under the wide range of conditions that are experienced in growing turf, such as geographical location, temperature, soil moisture, weed species and stage of growth, and other factors. Of note is application of at least about 0.05 lb per acre (about 56 g per hectare) of component (a) for weed control in turfgrass. Typically turf comprising Hybrid Bermudagrass is treated at an application rate not exceeding about 0.2 lb/ha (about 220 g/ha) on an acid-equivalent basis. Typically turf comprising St. Augustinegrass is treated at an application rate not exceeding about 0.15 lb/acre (about 170 g/ha) on an acid-equivalent basis. More typically the application rate is in the range of about 60 to about 150 g/hectare of component (a). One skilled in the art can readily determine for particular conditions through simple experimentation the optimal application rates for weed control without significant turfgrass injury. In addition, the variables that affect the precision of application of the compositions (for example, the quality and accuracy of the application equipment) make it very likely that higher rates of the component (a) herbicidal ingredient than intended may be applied by users of the products, especially by non-professional users. The application rate of the composition of the invention (i.e. herbicidally effective amount of the composition) is mathematically related to the application rate of component (a), and can be calculated by dividing the application rate of component (a) (i.e. herbicidally effective amount of component (a)) by the weight percentage of component (a) in the composition.

Thus, the benefits of this invention, as described herein, enable application of the component (a) herbicidal ingredient in a granular composition to control weeds without causing undue harm to warm-season turfgrasses to which the composition is applied. In contrast, liquid spray compositions used to apply similar application rates of the component (a) herbicidal ingredient have been found to cause unacceptable injury to warm-season turfgrasses.

The following specific examples are presented to further illustrate and explain certain aspects of the present invention. However, the examples are set forth for illustration only, and are not to be construed as limiting on the present invention. In the following examples, all percentages and parts are by weight unless otherwise specified. In the following examples, Compound 1 is identified in Table A and is also recognized as the methyl ester of the compound of Formula 1 (i.e. methyl 6-amino-5-chloro-2-cyclopropyl-4-pyrimidinecarboxylate). Compound 1 is being developed as a herbicide by the Crop Protection business of E. I. du Pont de Nemours and Company under code name DPX-KJM44 (“KJM44”).

### Examples of the Invention

### Example 1

This example illustrates the preparation of a granular herbicidal composition containing Compound 1 in accordance with the present invention and the phytotoxicity testing results achieved by applying this granular composition to St. Augustinegrass, a warm-season turfgrass, as compared with treatment of such turfgrass with a liquid spray formulation comprising Compound 1.

The granulated fertilizer employed to produce the composition for use in this example comprised a 29-2-4 formulation including urea, urea formaldehyde concentrate (UFC), potassium sulfate, monoammonium phosphate (MAP), ammonium sulfate and iron oxide. The fertilizer analysis comprised total nitrogen (TN) content of 29.8 weight percent based on the total fertilizer formulation, ammoniacal nitrogen content of 6.8 weight percent based on the total fertilizer formulation, urea nitrogen content of 12.2 weight percent based on the total fertilizer formulation, water-soluble organic nitrogen content of 9.2 weight percent based on the total fertilizer formulation, water-insoluble nitrogen content from methylene ureas of 0.8 weight percent based on the total fertilizer formulation and slowly available nitrogen content from methylene diureas (MDU) and dimethylene triureas (DMTU) of 6.7 weight percent based on the total fertilizer formulation.

The fertilizer analysis further comprised 2.1 weight percent based on the total fertilizer formulation of available phosphoric acid, 4.14 weight percent based on the total fertilizer formulation of potash and 9.26 weight percent based on the total fertilizer formulation of sulfur.

To prepare a granular composition of the present invention containing 0.088 weight percent of Compound 1, 0.7 weight percent of polybutene (tacking liquid) and 99 weight percent of the granulated fertilizer, a wettable powder formulation containing 25% by weight of Compound 1 and the tacking liquid were measured and metered into a rotating drum containing the granulated fertilizer. Polybutene, resulting from copolymerization of 1- and 2-butene with a small quantity of isobutylene, is well known as a non-drying, liquid polymer useful as a tacking liquid (i.e. sticking agent, adhesive). The ingredients were thoroughly mixed in the drum until Compound 1 was uniformly coated on and absorbed on the fertilizer granules.

The resulting composition produced by applying Compound 1 on the fertilizer granules yielded a Compound 1 analysis of 0.088% and this composition was evaluated for warm-season turfgrass injury by application on St. Augustinegrass at a rate of 0.115 lb Compound 1/acre (129 g Compound 1/hectare) (equivalent to an application rate of 130.68 lbs of the total composition/acre or 146.6 kg of total composition/hectare). In this regard, samples of the composition were pre-weighed and then each of the samples was applied, at the proper rate, in four replicated treatments to separate turf plots measuring 9 square feet (0.84 square meters) each.

In addition, four comparably sized plots were employed as control plots having no herbicidal composition applied thereto to provide a reference point to demonstrate that untreated plots would not display any harm to the warm-season turfgrass.

Also, for comparative purposes, a liquid spray formulation containing Compound 1 was prepared by measuring and placing in a standard sprayer device a wettable powder formulation containing 25% by weight of Compound 1 in an amount providing 0.356 lb/acre (162 g/ha) of the wettable powder formulation in 32.5 gallons/acre (304 L/hectare) equivalent water. The resulting spray formulation having the Compound 1 dissolved or dispersed in water was then evaluated for turfgrass injury in four replicated treatments by spraying on separate plots, each measuring 20 square feet (1.86 square meters), of St. Augustinegrass warm-season turfgrass using the amounts of wettable powder formulation and water described above to apply 0.089 lb of Compound 1/acre (100 g of Compound 1 /hectare).

Each treated test plot was irrigated after the compositions were applied thereto, and readings for turf injury were taken 28 or 29 days after treatment (“DAT”) for each of the various test plots. Turf injury was visually rated on a 1 to 9 scale wherein 1 means no turf injury, 2 means slight injury (growth reduction and/or color change), 3 means noticeable injury (slight to moderate growth retardation and/or chlorosis), 4 means moderate chlorosis and/or growth retardation, 5 means moderate to severe chlorosis and/or growth retardation with slight chlorosis, 6 means severe chlorosis and/or slight to moderate necrosis, 7 means moderate necrosis (rest of turf chlorotic), 8 means severe necrosis (only a small portion of the turf not brown, i.e. dead), and 9 means total necrosis (all turf brown, i.e. dead). A rating of 3 or higher is considered to represent significant injury. The results of this testing are tabulated in Table 1 as follows:

TABLE 1
Treatment of St. Augustinegrass with Compound 1

| | St. Augustinegrass |
|---|---|
| | Turfgrass Injury (1-9 scale, |
| | 1 means no injury) |
| Treatment | 28 or 29 DAT |
| Granular Compound 1/Fertilizer | 1.0 |
| Composition Applied at a Rate of | (Evaluated at 28 DAT) |
| 0.115 lbs Compound 1/acre (129 g | |
| Compound 1/hectare) | |
| Liquid Spray Formulation | 6.6 |
| Containing Compound 1 Applied at | (Evaluated at 29 DAT) |
| a Rate of 0.089 lbs | |
| Compound 1/acre (100 g | |
| Compound 1/hectare) | |
| Untreated Test Plots | 1.0 |

The results of the testing as tabulated in Table 1 show that the use of the liquid spray treatments comprising Compound 1 resulted in significant injury to St. Augustinegrass that would render this spray treatment commercially and functionally unacceptable. In contrast, applying the granular fertilizer compositions comprising Compound 1 according to the present invention to St. Augustinegrass resulted in no injury to this warm-season grass even at higher active ingredient application rates.

### Example 2

This example illustrates the preparation of a granular herbicidal composition containing Compound 1 in accordance with the present invention and the phytotoxicity testing results achieved by applying this granular composition to Palmetto St. Augustinegrass (a cultivar of St. Augustinegrass), a warm-season turfgrass, as compared with treatment of such turfgrass with a liquid spray formulation containing Compound 1.

A granular composition of the present invention containing 0.048 weight percent of Compound 1 on an acid-equivalent basis, 0.7 weight percent of polybutene (tacking liquid) and 99 weight percent of the granulated fertilizer of Example 1 was prepared in accordance with the procedure set forth in Example 1 herein involving measuring and metering a wettable powder formulation containing 10.9% by weight of Compound 1 on an acid-equivalent basis and 0.7 weight percent of polybutene (tacking liquid) into a rotating drum containing the granulated fertilizer. The ingredients were thoroughly mixed in the drum until Compound 1 was uniformly coated on and absorbed on the fertilizer granules.

The resulting composition produced by applying Compound 1 on the fertilizer granules yielded a Compound 1 analysis of 0.048% on an acid-equivalent basis. This composition was evaluated for warm-season turfgrass injury by separate application on dry Palmetto St. Augustinegrass turf and on dew-wet Palmetto St. Augustinegrass turf at a rate of 0.075 lb Compound 1/acre (84 g Compound 1/hectare) on an acid-equivalent basis (equivalent to an application rate of 156.3 lbs of the total composition/acre or 175.1 kg of the total composition/hectare). “Dew-wet” refers to the status of the turfgrass in the early morning before the dew dries from the leaves following natural dew formation. Samples of the compositions were pre-weighed and then each of the samples was applied, at the proper rate, in four replicated treatments to plots each measuring 9 square feet (0.84 square meters).

In addition, comparably sized plots were employed as control plots having no herbicidal composition applied thereto to provide a reference point to demonstrate that untreated turf plots would not display any harm to the warm-season turfgrass.

For comparative purposes, a liquid spray formulation comprising Compound 1 was prepared in accordance with the procedure in Example 1 by measuring and placing in a standard sprayer device a wettable powder formulation containing 23.5% by weight, on acid-equivalent basis, of Compound 1 in an amount providing an application rate of 0.319 lb/acre (145 g/ha) of the wettable powder formulation in 30.0 gallons/acre (281 L/hectare) equivalent water. As in Example 1, the resulting spray formulation having Compound 1 dissolved or dispersed in water was then evaluated for turfgrass injury in four replicated treatments by spraying on separate plots, each measuring 20 square feet (1.86 square meters), of dry and dew-wet Palmetto St. Augustinegrass turf using the amounts of the wettable powder formulation and water described above to apply 0.075 lb Compound 1/acre (84 g/ha) of Compound 1 on an acid-equivalent basis.

Each treated test plot was irrigated after the compositions were applied thereto and readings for turf injury were taken 14 days after treatment (“DAT”) for each of the test plots. A rating of the turf injury observed in the various test grass plots (based on a scale of 1 to 9, with 1 indicating no injury and 9 indicating death of the treated turf as defined in Example 1) was recorded, and the results of this testing are tabulated in Table 2 as follows:

TABLE 2
Treatment of Palmetto St. Augustinegrass with Compound 1

Turfgrass Injury
(1-9 scale, 1 means
no injury)
Palmetto St.
Augustinegrass
14 DAT

| | Applied | Applied to |
|---|---|---|
| Treatment | to dry turf | dew-wet turf |
| Granular Compound 1/Fertilizer | 1.5 | 1.5 |
| Composition Applied at a Rate of | | |
| 0.075 lbs/acre (84 g Compound | | |
| 1/ha) on a Acid-Equivalent Basis | | |
| Liquid Spray Formulation | 5.0 | 4.5 |
| Containing Compound 1 Applied | | |
| at a Rate of 0.075 lbs/acre (84 g | | |
| Compound 1/ha) on a Acid- | | |
| Equivalent Basis | | |
| Untreated Test Plots | 1.0 | 1.0 |

The results of the testing as tabulated in Table 2 show that the use of the liquid spray treatments containing Compound 1 resulted in significant injury to dry or dew-wet Palmetto St. Augustinegrass turf that would render this spray treatment commercially and functionally unacceptable. In contrast, applying the granular fertilizer compositions comprising Compound 1 according to the present invention to Palmetto St. Augustinegrass turf resulted in very little injury to either the dry or dew-wet turf of this warm-season grass at the same active ingredient application rate.

### Example 3

This example illustrates the preparation of a granular herbicidal composition containing Compound 1 in accordance with the present invention and the phytotoxicity testing results achieved by applying this granular composition to a Tifway Hybrid Bermudagrass variety and to a TifSport Hybrid Bermudagrass variety, which are examples of two other warm-season turfgrasses, as compared with treatment of such turfgrasses with a liquid spray formulation containing Compound 1.

The granulated fertilizer employed to produce the composition for use in this example comprised a 28-3-3 formulation including urea, urea formaldehyde concentrate, potassium sulfate, monoammonium phosphate and ammonium sulfate. The fertilizer analysis comprised total nitrogen content of 28.61 weight percent based on the total fertilizer formulation, ammoniacal nitrogen content of 8.5 weight percent based on the total fertilizer formulation, urea nitrogen content of 10.2 weight percent based on the total fertilizer formulation, water-soluble organic nitrogen content of 7.6 weight percent based on the total fertilizer formulation, water-insoluble nitrogen content from methylene ureas of 0.7 weight percent based on the total fertilizer formulation and slowly available nitrogen content from methylene diureas and dimethylene triureas of 5.6 weight percent based on the total fertilizer formulation. The fertilizer analysis further comprised 3.11 weight percent based on the total fertilizer formulation of available phosphoric acid; 3.11 weight percent based on the total fertilizer formulation of potash and 11.05 weight percent based on the total fertilizer formulation of sulfur.

A granular composition of the present invention containing 0.048 weight percent of Compound 1 on an acid-equivalent basis, 0.7 weight percent of polybutene (tacking liquid) and 99 weight percent of the granulated fertilizer was prepared in accordance with the procedure set forth in Example 1 herein involving measuring and metering a wettable powder formulation containing 10.9% by weight of Compound 1 on an acid-equivalent basis and tacking liquid into a rotating drum containing the granulated fertilizer. The ingredients were thoroughly mixed in the drum until Compound 1 was uniformly coated on and absorbed on the fertilizer granules.

The resulting composition produced by applying Compound 1 on the fertilizer granules yielded a Compound 1 analysis of 0.048% on an acid-equivalent basis. This composition was evaluated for warm-season turfgrass injury by separate application on dry and dew-wet Tifway Hybrid Bermudagrass turf and on dry and dew-wet TifSport Hybrid Bermudagrass turf at a rate of 0.075 lb Compound 1/acre (84 g Compound 1/hectare) on an acid-equivalent basis (equivalent to an application rate of 156.3 lbs of the total composition/acre or 175.1 kg of the total composition/hectare). Samples of the compositions were pre-weighed and then each of the samples was applied, at the proper rate, in four replicated treatments to separate dry and dew-wet turf plots of Tifway Hybrid Bermudagrass and TifSport Hybrid Bermudagrass each measuring 9 square feet (0.84 square meters).

In addition, comparably sized plots were employed as control plots of having no herbicidal composition applied thereto to provide a reference point to demonstrate that untreated dry and dew-wet plots of Tifway Hybrid Bermudagrass and TifSport Hybrid Bermudagrass turf would not display any harm to the warm-season turfgrass.

For comparative purposes, a liquid spray formulation containing Compound 1 was prepared in accordance with the procedure in Example 1 by measuring and placing in a standard sprayer device a wettable powder formulation containing 23.5% by weight, on an acid-equivalent basis, of Compound 1 in an amount providing an application rate of 0.319 lb/acre (145 g/ha) of the wettable powder formulation in 30.0 gallons/acre (281 L/hectare) equivalent water. As in Example 1, the resulting spray formulation having the Compound 1 dissolved or dispersed in water was then evaluated for turfgrass injury in four replicated treatments by spraying on separate plots, each measuring 9 square feet (0.84 square meters), of dry and dew-wet Tifway Hybrid Bermudagrass and TifSport Hybrid Bermudagrass turf using the amounts of the wettable powder formulation and water described above to apply 0.075 lb/acre (84 g/hectare) of Compound 1 on an acid-equivalent basis.

Each treated test plot was irrigated after the compositions were applied thereto and readings for turf injury were taken 14 days after treatment (“DAT”) for each of the test plots. A rating of the turf injury observed in the various test grass plots (based on a scale of 1 to 9, with 1 indicating no injury and 9 indicating death of the treated turf as defined in Example 1) was recorded, and the results of this testing are tabulated in Tables 3 and 4 as follows:

TABLE 3
Treatment of Tifway Hybrid Bermudagrass with Compound 1

Turfgrass Injury
(1-9 scale, 1
means no injury)
Tifway Hybrid
Bermudagrass
14 DAT

| | Applied to | Applied to |
|---|---|---|
| Treatment | dry turf | dew-wet turf |
| Granular Compound 1/ | 1.0 | 1.0 |
| Fertilizer Composition | | |
| Applied at a Rate of 0.075 lbs | | |
| Compound 1/acre (84 g | | |
| Compound 1/ha) on a Acid- | | |
| Equivalent Basis | | |
| Liquid Spray Formulation | 5.3 | 3.3 |
| Containing Compound 1 | | |
| Applied at a Rate of 0.075 lbs | | |
| Compound 1/acre (84 g | | |
| Compound 1/ha) on a Acid- | | |
| Equivalent Basis | | |
| Untreated Test Plots | 1.0 | 1.0 |

TABLE 4
Treatment of TifSport Hybrid Bermudagrass with Compound 1

| | Turfgrass Injury | |
|---|---|---|
| | (1-9 scale, 1 means no injury) | |
| | TifSport Hybrid Bermudagrass | |
| | 14 DAT | |
| Treatment | Applied to dry turf | Applied to dew-wet turf |
| Granular Compound 1/ | 2.0 | 1.0 |
| Fertilizer Composition | | |
| Applied at a Rate of | | |
| 0.075 lbs/acre (84 g | | |
| Compound 1/ha) on a | | |
| Acid-Equivalent Basis | | |
| Liquid Spray | 6.3 | 7.0 |
| Formulation Containing | | |
| Compound 1 Applied at | | |
| a Rate of 0.075 lbs/acre | | |
| (84 g Compound 1/ha) | | |
| on a Acid-Equivalent | | |
| Basis | | |
| Untreated Test Plots | 1.0 | 1.0 |

The results of the testing as tabulated in Tables 3 and 4 show that the use of the liquid spray treatments containing Compound 1 resulted in significant injury to Tifway Hybrid Bermudagrass and TifSport Hybrid Bermudagrass turf, either dry or dew-wet, that would render this spray treatment commercially and functionally unacceptable. In contrast, applying the granular fertilizer composition comprising Compound 1 according to the present invention to Tifway Hybrid Bermudagrass turf and TifSport Hybrid Bermudagrass turf resulted in very little to no injury in either the dry or dew-wet turf of these warm-season grasses at the same active ingredient application rates.

### Example 4

This example illustrates the preparation of a granular herbicidal composition containing Compound 1 in accordance with the present invention and the phytotoxicity testing and weed control results achieved by applying this granular composition to turf comprising common centipedegrass, a warm-season turfgrass, infested with annual lespedeza (Kummerowia striata (Thunb.) Schindl., also known as Lespedeza striata (Thunb.) Hook. & Arn.) as compared with treatment of such turf with a liquid spray formulation comprising Compound 1.

The granulated fertilizer employed to produce the composition for use in this example comprised a 28-3-3 formulation including urea, urea formaldehyde concentrate, potassium sulfate, monoammonium phosphate and ammonium sulfate. The fertilizer analysis comprised total nitrogen content of 28.61 weight percent based on the total fertilizer formulation, ammoniacal nitrogen content of 8.5 weight percent based on the total fertilizer formulation, urea nitrogen content of 10.2 weight percent based on the total fertilizer formulation, water-soluble organic nitrogen content of 7.6 weight percent based on the total fertilizer formulation, water-insoluble nitrogen content from methylene ureas of 0.7 weight percent based on the total fertilizer formulation and slowly available nitrogen content from methylene diureas and dimethylene triureas of 5.6 weight percent based on the total fertilizer formulation. The fertilizer analysis further comprised 3.11 weight percent based on the total fertilizer formulation of available phosphoric acid, 3.11 weight percent based on the total fertilizer formulation of potash and 11.05 weight percent based on the total fertilizer formulation of sulfur.

A granular composition of the present invention was prepared in accordance with the procedure set forth in Example 1 herein containing 0.064 weight percent of Compound 1 on an acid-equivalent basis, 0.7 weight percent of polybutene (tacking liquid) and 99 weight percent of a granulated fertilizer by measuring and metering a wettable powder formulation containing 10.9% by weight of Compound 1 on an acid equivalent basis and tacking liquid into a rotating drum containing the granulated fertilizer and mixing the ingredients thoroughly in the drum until Compound 1 was uniformly coated on and absorbed on the fertilizer granules.

The resulting composition produced by applying Compound 1 on the fertilizer granules yielded a Compound 1 analysis of 0.064% on an acid-equivalent basis. This composition was evaluated for warm-season turfgrass injury by application on turf at a rate of 0.1 lb Compound 1/acre (112 g Compound 1/hectare) on an acid-equivalent basis (equivalent to an application rate of 156.3 lbs/acre or 175 kg/hectare of the total composition). Samples of the compositions were pre-weighed and then each of the samples was applied, at the proper rate, in four replicated treatments to plots of common centipedegrass each measuring 9 square feet (0.84 square meters).

In addition, comparably sized plots were employed as control plots of having no herbicidal composition applied thereto to provide a reference point to demonstrate that plots of untreated common centipedegrass turf would not display any harm to the warm-season turfgrass.

For comparative purposes, a liquid spray formulation containing Compound 1 was prepared in accordance with the procedure in Example 1 by measuring and placing in a standard sprayer device a wettable powder formulation containing 23.5% by weight of Compound 1, on an acid-equivalent basis, in an amount providing an application rate of 0.426 lb/acre (478 g/hectare) of the wettable powder formulation in 25.0 gallons/acre (234 L/hectare) equivalent water. As in Example 1, the resulting spray formulation having Compound 1 dissolved or dispersed in water was then evaluated for turfgrass injury and weed control in four replicated treatments by spraying on separate plots, each measuring 9 square feet (0.84 square meters), of common centipedegrass turf infested with annual lespedeza using the amounts of the wettable powder formulation and water described above to apply 0.1 lb lb/acre (112 g/hectare) of Compound 1 on an acid-equivalent basis.

Each treated test plot was irrigated after the compositions were applied thereto and readings for turf injury were taken 27 days after treatment (“DAT”) for each of the test plots. A rating of the turf injury observed in the various test grass plots (based on a scale of 1 to 9, with 1 indicating no injury and 9 indicating death of the treated turf as defined in Example 1) was recorded, and the results of this testing are tabulated in Table 5.

Readings for annual lespedeza weed control were taken 27 days and 57 days after treatment (“DAT”). A rating scale of 0-100 was used for weed control evaluation where “0” means no control and “100” means total weed control. The results of this testing are also tabulated in Table 5.

TABLE 5
Treatment of Centipedegrass and Annual Lespedeza with Compound 1

| | | Weed Control | |
|---|---|---|---|
| | | (0-100 scale, | |
| | Turfgrass Injury | 0 means no | |
| | (1-9 scale, 1 means no | control) | |
| | injury) | Annual | |
| | Common Centipedegrass | Lespedeza | |
| Treatment | 27 DAT | 27 DAT | 57 DAT |
| Granular Compound 1/ | 2.4 | 100.0 | 100.0 |
| Fertilizer Composition | | | |
| Applied at a Rate of 0.1 lbs | | | |
| Compound 1/acre (112 g | | | |
| Compound 1/hectare) on an | | | |
| Acid-Equivalent Basis | | | |
| Liquid Spray Formulation | 3.2 | 100.0 | 100.0 |
| Containing Compound 1 | | | |
| Applied at a Rate of | | | |
| 0.1 lbs/acre (112 g | | | |
| Compound | | | |
| 1/hectare) on and Acid- | | | |
| Equivalent Basis | | | |
| Untreated Test Plots | 1.0 | 0.0 | 0.0 |

The results of the testing as tabulated in Table 5 shows that while both the liquid spray treatment and the application of the granular composition of Compound 1 both controlled the commercially important turf weed annual lespedeza, the liquid spray treatment caused substantially more serious injury than the granular composition to centipedegrass. This level of injury would render the spray treatment commercially or functionally unacceptable.

Although the invention has been described in its preferred forms with a certain degree of particularity, it is to be understood that the present disclosure is not limited by the examples. Numerous changes in the details of the compositions and ingredients therein as well as the methods of preparation and use will be apparent to those skilled in the art without departing from the spirit and scope of the invention as defined in the appended claims.

What is claimed is:

1. A granular herbicidal composition comprising (a) one or more compounds selected from the compound of Formula 1 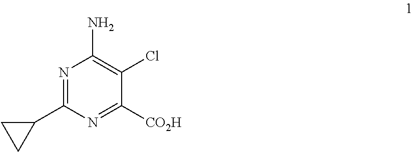
and salts, esters and thioesters thereof, coated on or impregnated into (b) a granular substrate material.

2. The composition of claim 1 wherein component (a) is from about 0.005% to about 2% by weight of the composition on an acid-equivalent basis.

3. The composition of claim 1 wherein component (a) comprises the methyl ester of the compound of Formula 1.

4. The composition of claim 1 wherein the granular substrate comprises solid fertilizer granules.

5. The composition of claim 4 wherein the solid fertilizer granules comprise one or more compounds selected from the group consisting of organic and inorganic nitrogen-containing compounds, potassium salts and phosphoric acid and/or salts of phosphoric acid.

6. The composition of claim 5 wherein the organic and inorganic nitrogen-containing compounds are selected from the group consisting of urea, urea-formaldehyde condensation products, amino acids, ammonium nitrate and other ammonium salts.

7. The composition of claim 4 wherein the fertilizer granules comprise one or more micronutrients selected from the group consisting of iron, manganese, magnesium, boron, copper and zinc.

8. The composition of claim 4 wherein the fertilizer granules have diameters within a range from about 1 to about 5 mm.

9. The composition of claim 4 wherein the fertilizer granules include extruded particles.

10. The composition of claim 9 wherein the extruded particles have diameters within a range from about 0.6 to 7 mm and lengths within a range from about 0.6 to 10 mm.

11. A method for controlling weeds in turf comprising a warm-season turfgrass without causing significant injury to the warm-season turfgrass, the method comprising applying a herbicidally effective amount of the composition of claim 1 to the turf.

12. The method of claim 11 wherein the composition is applied at an application rate in the range from about 28 g/ha to about 220 g/ha of component (a) on an acid-equivalent basis.

13. The method of claim 12 wherein the composition is applied at an application rate in the range from about 28 g/ha to about 170 g/ha of component (a) on an acid-equivalent basis.

14. The method claim 11 wherein the composition is applied postemergence to the turfgrass.

15. The method of claim 11 wherein the turf comprises one or more turfgrasses selected from the group consisting of Axonopus fissifolius, Bouteloua dactyloides, Cynodon dactylon, Cynodon dactylon x C. transvaalensis, Eremochloa ophiuroides, Paspalum notatum, Paspalum vaginatum, Stenotaphrum secundatum, Zoysia japonica, Zoysia matrella and Zoysia tenuifolia.

16. The method of claim 15 wherein the turf comprises one or more turfgrasses selected from the group consisting of Cynodon dactylon, Cynodon dactylon x C. transvaalensis, Eremochloa ophiuroides, Paspalum notatum, Paspalum vaginatum, Stenotaphrum secundatum, Zoysia japonica, Zoysia matrella and Zoysia tenuifolia.

17. The method of claim 16 wherein the turf comprises one or more turfgrasses selected from the group consisting of Cynodon dactylon x C. transvaalensis and Stenotaphrum secundatum.
